(19) United States
(12) Patent Application Publication
(10) Pub. No.: US 2002/0182318 A1
(43) Pub. Date: Dec. 5, 2002

(54) Hand-held adhesive trough

(76) Inventor: Stephen L. Kruskamp, Fair Oaks, CA (US)

Correspondence Address: Stephen Kruskamp, Kruskamp Tools, 7212 Walnut Road, FairOaks, CA, 95628, US

(21) Appl. No.: 09/872,530

(22) Filed: Jun. 1, 2001

(51) Int. Cl. B05C 21/00; B05D 5/10

(52) U.S. Cl. 427/207.1; 15/218.1; 15/220.4; 15/236.06; 15/236.09; 15/257.01; 15/257.05

(57) ABSTRACT

A hand-held adhesive trough is provided which enables a floor or wall installer to comfortably hold in one hand an adhesive trough while using a bladed tool such as a trowel or tape knife with the other hand to apply adhesive to an underlying surface to which a floor or wall is to be installed. The trough includes a first compartment for fresh adhesive, and a second compartment for contaminated adhesive removed from the blade of the trowel. A trowel blade cleaner is incorporated in a wall of the second compartment to enable the installer to clean the trowel while holding the trough by sliding the blade through a v-shaped slot, with the old, contaminated adhesive falling from the blade into the second compartment. The compartments may include removable, disposable liners to ease clean-up. A comfortable, pistol-grip type handle is provided which may include a two-part adhesive for allowing the installer to form a custom-grip handle which conforms to the installer's grip.

### TECHNICAL FIELD OF THE INVENTION

This invention relates generally to tools used for floor and wall installation, and more particularly to troughs used in conjunction with bladed tools for applying adhesive during the installation of floors and walls.

### BACKGROUND OF THE INVENTION

Adhesives or mortar are frequently used for installing many types of floors and walls. The adhesive is typically applied to a surface with a bladed took such as, for example, a hand trowel, putty knife, tape knife, or the like. Such blades may be smooth or toothed, depending upon whether it is desired to create ridges in the adhesive. Adhesive may also be applied to, for example, joints between wallboard, and then covered with tape.

Once the adhesive has been applied to the desired surface, the flooring, or wall covering is laid smoothly and progressively over the adhesive with pressure to remove any air bubbles and to form a tight, adhesive bond with the underlying surface. Because many adhesives cure relatively quickly, it is important that the operator be able to rapidly, yet correctly, apply the adhesive layer.

Contamination of the adhesive on the tool blade is common, as the adhesive on the blade dries and as the installer encounters debris on the underlying surface. Such contaminated adhesive can adversely affect the performance of the tool blade. This problem can be eliminated by using a slotted device such as those disclosed in U.S. Pat. No. 5,839,152, which is incorporated herein by reference, to periodically clean the blade of the tool being used to apply the adhesive. However, those devices are intended to be used in conjunction with a conventional bucket-sized container of adhesive which are typically heavy and difficult to manipulate, increasing installation time.

Accordingly, the need exists for an adhesive trough which can be easily and comfortably held in one hand of the installer as the installer wields a bladed hand tool, such as a trowel, for applying adhesive, and which includes a means for periodically cleaning the tool blade when necessary without the need for laying down the adhesive trough or using a separate device.

### SUMMARY OF THE INVENTION

In one embodiment, the present invention provides a hand-held trough for use with a bladed hand tool for applying adhesive to a surface, the trough having a first compartment for holding clean adhesive and a second compartment for holding contaminated adhesive, the second compartment including a cleaning slot mounted in a wall of the second compartment for cleaning the tool blade and a handle extending away from a bottom surface of the trough of sufficient size to be comfortably grasped by a user.

In another embodiment, a trough of the present invention additionally includes an arm rest on a rear portion of the trough for resting the trough on a forearm of the user when the handle is grasped by the user for spreading the load along the forearm of the user. The arm rest may be flat or arched to conform it to the curvature of the user's forearm, and may include a means for attaching the arm rest to the user's forearm.

In yet another embodiment, a disposable liner is provided for the second compartment which, when full of contaminated waste adhesive, can be removed and disposed of.

In yet another embodiment, a disposable liner is provided for the first compartment which can be sold as a sealed unit full of the appropriate adhesive. This disposable adhesive container can be dropped into the first compartment, and a sealed cover removed to allow the user to begin applying adhesive. This embodiment eliminates the need to transfer adhesive from a larger container to the first compartment, and further substantially eliminates the need for messy cleanup once the job has been completed.

In yet another embodiment, a trough of the present invention includes a handle which can be easily adapted by the user to provide a custom grip to fit the user.

Other and further objects, features, advantages and embodiments of the present invention will become apparent to one skilled in the art from reading the Detailed Description of the Invention together with the drawings.

### BRIEF DESCRIPTION OF THE DRAWINGS:

FIG. 1 is a perspective side view of a trough of the present invention;

FIG. 2 is a perspective top view of a trough of the present invention.

FIGS. 3a through 3d are alternate rear views of a trough of the present invention;

FIG. 4 is a perspective side view of a trough of the present invention;

FIG. 5 is a perspective side view of a trough of the present invention; and

FIG. 6 is a sectional view of the trough of FIG. 5 taken through line 6-6.

### DETAILED DESCRIPTION OF THE INVENTION

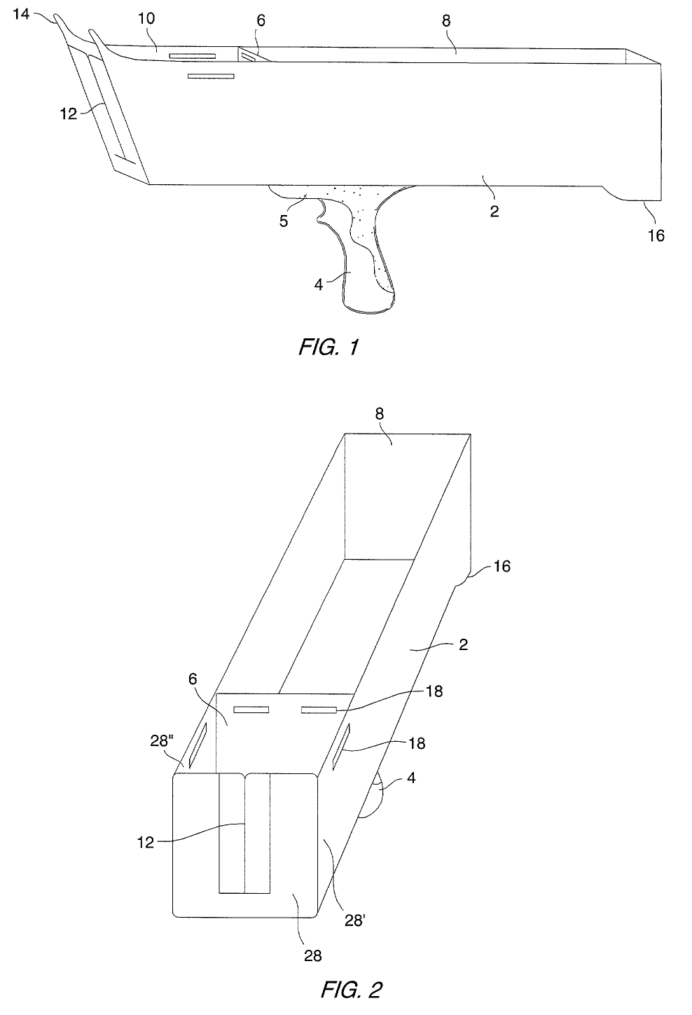

As shown in FIGS. 1 and 2, a hand-held trough 2 of the present invention includes a handle 4 and a divider 6 which divides the trough 2 into a first compartment 8 and a second compartment 10. First compartment 8 is used to hold clean adhesive to be applied to a work surface, while second compartment 10 is used to contain contaminated adhesive removed from the blade of the tool used to apply the adhesive. “Tool blade” for the purposes of this disclosure means any kind of tool blade intended for the application of adhesive compositions, including, without limitation, trowels, putty knives, tape knives, and the like.

Trough 2 and divider 6 are typically constructed of sheet metal. They may also be formed from any durable, rigid material such as, for example, plastic or fiberglass.

Handle 4 can be any conventional device suitable for being grasped by a human hand. I prefer a pistol-grip type handle as shown, which is ergonomically designed to be comfortable to grasp and which allows the user to easily control the trough 2 even when the first compartment is full of adhesive composition. Handle 4 can be formed as a unitary structure with the bottom surface of trough 2 where trough 2 is formed from molded plastic or handle 2 can be a separate structure attached by conventional means to the bottom surface of trough 2. Such conventional means may include, for example, providing a threaded rod extending from a top portion of handle 4 for attaching it to a bottom surface of trough 2, or handle 4 may be attached to the bottom surface of trough 2 using a flange 5 which extends along a top surface of handle using conventional means such as, for example, adhesive, rivets or threaded fasteners. Handle 4 preferably has a substantially rigid interior or core to prevent substantial deflection of the handle when grasped, in combination with a cushioned outer surface textured to provide a comfortable, secure, no-slip type grip, and is preferably mounted to the bottom surface of the trough 2 between the center of gravity or balance and the front of trough 2. Handle 4 can also be provided with two different surfaces, if desired: one more cushioned for the palm of the hand, and a non-slip surface to be gripped by the fingers. The surface for the fingers can be shaped to provide individual channels or depressions into which individual fingers can fit.

As shown in FIG. 6, in one embodiment, a handle 4 can be provided which can be modified by the user to provide custom fit grip which fits the user's hand exactly. Handle 4 of this embodiment include a substantially rigid core 30 which can, if desired, be a rod which can be threaded and used to mount handle 4 to the bottom of the trough 2. Shaft 30 can be covered by a sealed, cushioned outer cover 32, which is preferably deformable and elastic. A two-part adhesive (such as, for example, a two part epoxy) can be contained within the sealed outer cover 32 with a first part 34 of the two parts separated from the second part 36, for example by providing the second part in rupturable capsules 36 or in a membrane. The user ruptures the membrane or capsules 36 releasing the second part to mix with the first part to form the adhesive by squeezing the outer cover 32 against the core 30. Then the user need only grasp the handle 4 in the usual way to conform the handle to his hand and, when the fast-curing adhesive dries, a custom-formed cushioned grip is produced on handle 4 which fits the user's hand exactly. Alternatively, a molded inner handle surface can be wrapped with a membrane containing the two-part adhesive described above which can be squeezed by the user to rupture the container for one part of the adhesive, mixed, and gripped by the user to form the custom hand grip. This type of handle is particularly useful to the physically handicapped user, since it provides a custom grip like no other.

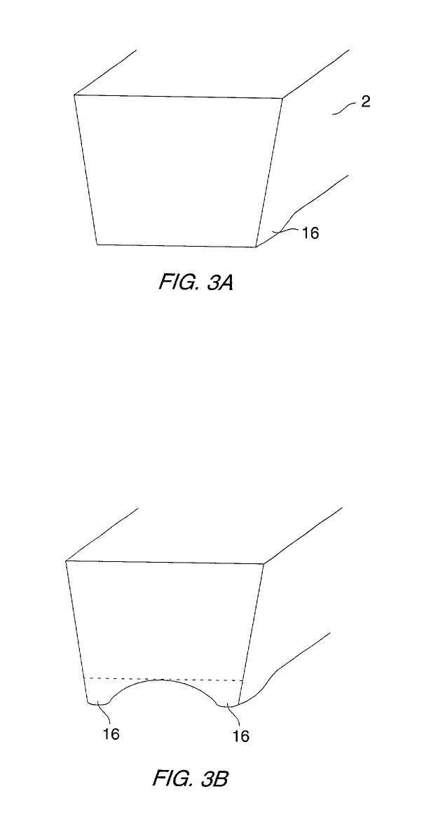

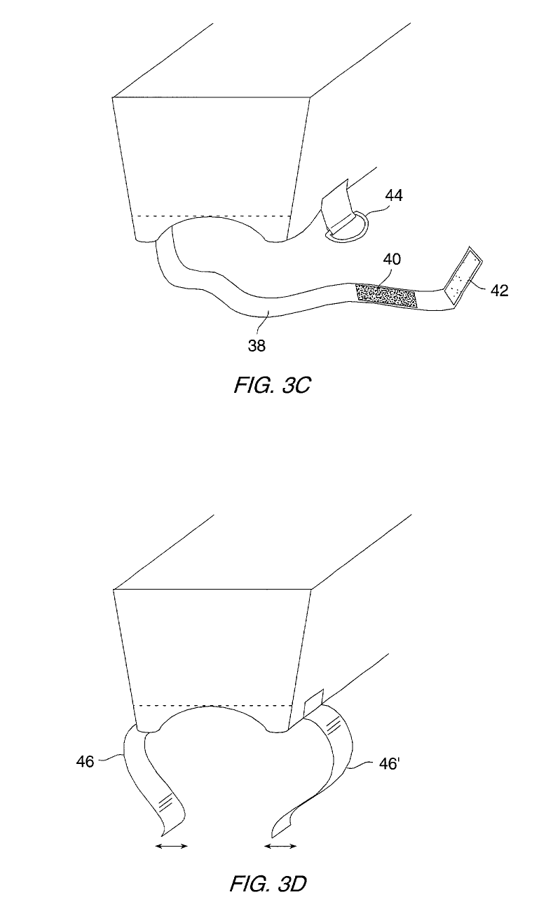

Returning to FIGS. 1 and 2, trough 2 is preferably also provided with an arm rest 16. Arm rest 16 aids in spreading the load of the trough 2 along the forearm of the user to the handle 4, making it easier for the user to control the trough 2 during use and substantially reducing the fatigue to the user's hand and wrist. While I prefer the flat arm rest of FIG. 3A, an arched arm rest, as shown in FIG. 3B, which conforms to a curved surface, can also be used if desired. Arm rest 16 can be formed as a unitary structure with the trough 2, or can be a separate structure mounted to a bottom surface of trough 2. As a separate structure, arm rest 16 could be constructed from any durable material, and may be either rigid or cushioned as desired. As shown in FIGS. 3C and 3D, arm rest 16 can be supplemented by adding a means for securing it to the forearm of a user. For example, a flexible strap 38 can be mounted to the rear portion of the trough 2 for engaging a D-Ring 44 or similar hardware using conventional hook 42 and pile 40 fastening elements in a conventional way to strap the rear portion of the trough 2 to the user's forearm. Alternately, as shown in FIG. 3D, arm rest 16 can include two downwardly depending spring bars 46, 46′ shaped to conform generally to the user's forearm, and sufficiently springy to move away from each other when pushed over a user's forearm and to automatically move back towards each other to grip the user's forearm when the forearm is positioned between the spring bars 46, 46′. The spring bars 46, 46′ may be formed and mounted on the trough 2 to conveniently form, with handle 4 a three-point stand for supporting the trough 2 in a substantially horizontal position on a flat surface when not in use.

As shown in FIGS. 1 and 2, a slot 12 is provided in one of the walls 28, 28′, 28′ of the second compartment for the purpose of cleaning the tool blade. Most preferably, slot 12 is provided in the front wall 28, thus enabling trough 2 to be readily used by either right-handed or left-handed users. Slot 12 is formed from two blades positioned parallel to each other and spaced apart a sufficient distance to allow a tool blade to be passed between them, but close enough to thoroughly scrape the tool blade clean of contaminated adhesive. A “v” shaped notch is most preferably provided at the top of the slot 12 to aid in guiding the tool blade into slot 12. The two blades of slot 12 are most preferably formed from sheet metal, but may be formed from any other durable, substantially rigid material capable of being repeatedly scraped without breaking. The two blades of slot 12 are mounted in wall 28 by welding, riveting or any other conventional means.

As shown in FIG. 1, a raised front edge 14 can be provided on one or both walls 28′, 28″ of the second compartment, if desired. Such raised front edges are used to provide an additional scraping surface which can be advantageously used to clean wide blades.

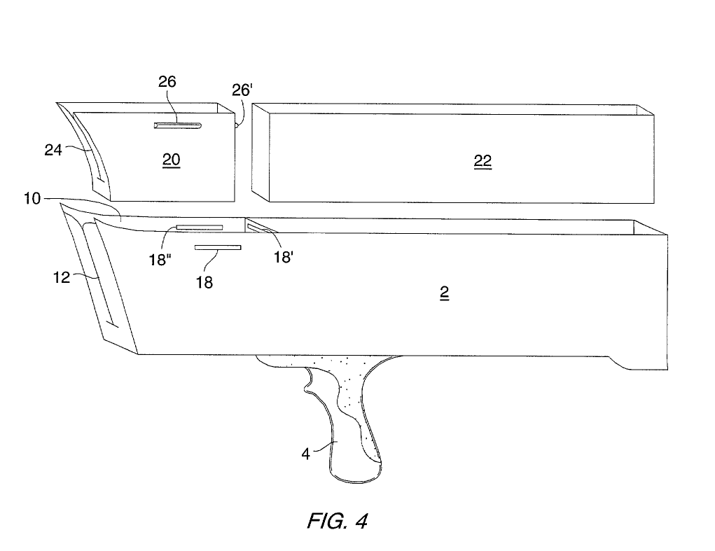

As shown in FIG. 4, a disposable plastic insert 20 can be formed to fit the interior of the second compartment 10. Plastic insert 20 is preferably provided with a slot 24 aligned with slot 12 when the insert 20 is inserted into second compartment 10. Slot 24 allows the tool blade to pass through into the plastic insert 20 so that any contaminated adhesive is scraped off of the tool blade and falls into the plastic insert 20. When the plastic insert 20 becomes full, it can be removed from the second compartment 10 and disposed of. To maintain the alignment of slots 12 and 24, a means for removably securing the insert 20 in position in the second compartment 10 is preferred. For example, grooves or slots 18, 18′, 18″ could be provided on the walls 28′, 28″ and divider 6 for engaging ridges 26, 26′, and 26″ (not shown) for removably holding the insert 20 in place. Ridges 26, 26′, 26″ can be easily disengaged by grasping a wall of the liner and pulling it up and out of the second compartment 10, or by inverting the trough 2 and tapping it, for example on the edge of a trash container, so that the liner 20 can fall out. Any other conventional means of removably securing the liner can also be used, including, for example, ball detent means cooperating with one or more slots or holes in the liner 20, fabric hooks cooperating with fabric pile, tape, straps, and the like.

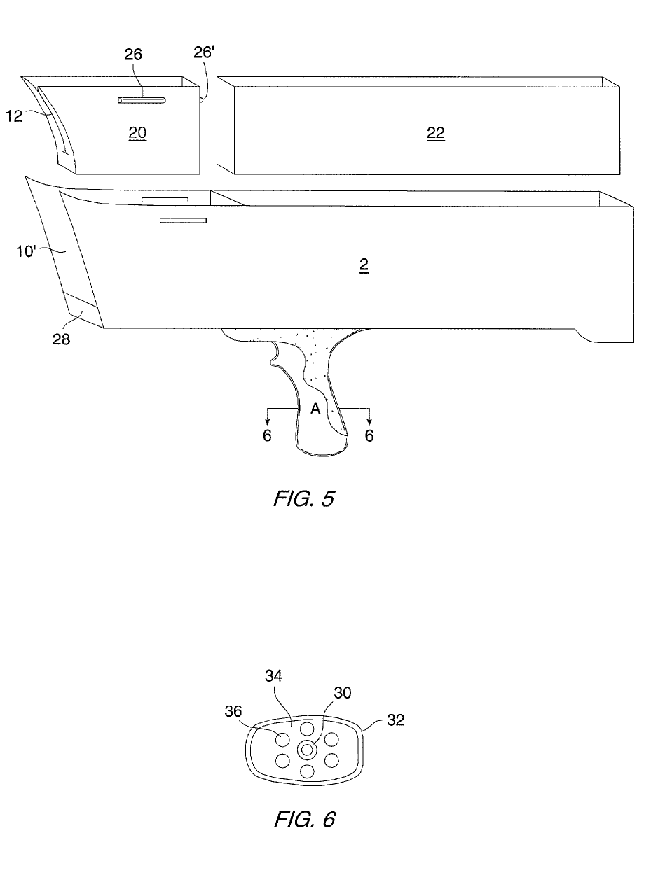

As shown in FIG. 5, a disposable or removable plastic insert 20′ could also be used to form the second compartment 10. In this embodiment, the groove 12 is formed on the front wall of the plastic insert 20. The wall 28 is reduced in size from prior embodiments to form a stop to prevent the removable plastic insert 20′ from sliding forward during scraping. Conventional means for securing the liner 20′ in the cavity 10′, such as those described in detail above, are also used to removably hold the liner 20′ in position.

As can be appreciated, it would also be possible to telescope multiple inserts 20, 20′ together for convenience. The user would then separate and discard the top insert when full from the bottom empty insert or inserts. A upwardly extending tab or other device could be provided on the inserts to assist the user in removing the full insert from the trough and/or from any underlying empty inserts.

As shown in FIGS. 4 and 5, a liner 22 may also be provided for the first compartment 8. Such a liner 22 may be open and fillable with adhesive from a larger container. In this embodiment, the liner 22 is advantageous as it may be removed from the trough 2 and disposed of when the task is completed, substantially obviating messy clean up of the trough 2. In another embodiment, adhesive may be provided in the liner 22, and the liner 22 sealed using a removable film. Thus, when it is desired to apply adhesive to a work surface, the adhesive filled, sealed liner 22 is inserted into the first compartment 8, the film removed to expose the adhesive, and the tool blade inserted to remove and apply adhesive as needed. When the job has been completed, the liner 22 can be removed and disposed of. As discussed above for liner 20, if desired engagement means can be provided to secure the liner 22 in the first compartment 8 until it is desired to remove liner 22.

Liners 20, 22 are most preferably formed of thin plastic.

One skilled in the art will recognize at once that it would be possible to construct the present invention from a variety of materials and in a variety of different ways. While the preferred embodiments have been described in detail, and shown in the accompanying drawings, it will be evident that various further modification are possible without departing from the scope of the invention as set forth in the appended claims.

What is claimed is:

1. A hand-held trough for use with a bladed tool for applying adhesive, comprising:
a trough having a first compartment for clean adhesive and a second compartment for contaminated adhesive;
a cleaning slot mounted in a wall of said second compartment for cleaning a blade of the bladed tool; and,
a handle extending away from a bottom surface of said trough of sufficient size to be comfortably grasped by a user.

2. The trough of claim 1 additionally including an arm rest on a rear portion of said trough for resting said trough on a forearm of said user when said handle is grasped by said user.

3. The trough of claim 2 wherein said arm rest includes a means for attaching said armrest to the forearm of the user.

4. The trough of claim 1 wherein said cleaning slot is mounted in a front wall of said cleaning compartment.

5. The trough of claim 1 additionally including a disposable liner for the second compartment.

6. The trough of claim 5 wherein said disposable second compartment liner contains a slot aligned with said cleaning slot when said disposable liner is inserted into said second compartment.

7. The trough of claim 5 wherein said second compartment includes attachment means for engaging said second compartment liner.

8. The trough of claim 5 wherein said second compartment liner includes attachment means for engaging said second compartment.

9. The trough of claim 7 wherein said second compartment liner includes means for engaging said attachment means.

10. The trough of claim 1 wherein said second compartment is formed by a removable liner.

11. The trough of claim 1 including a removable first compartment liner.

12. The trough of claim 1 wherein said handle is a cushioned, pistol grip-type handle mounted between the center of gravity of said trough and a front wall of the second compartment.

13. The trough of claim 1 wherein said handle includes a substantially rigid core covered by a sealed, cushioned cover, and containing within said cover a two part adhesive which when mixed will solidify, one part of said two part adhesive being contained in a compartment rupturable by the user, whereby when the user ruptures the compartment containing the one part of the adhesive and mixes the two parts of the adhesive together, and grasps the handle in a normal gripping position, the adhesive will cure and the resulting handle will be permanently conformed to the hand of the user.

14. The trough of claim 12 wherein the outside surface of said handle is textured to provide a non-slip surface.

15. A hand-held trough for use with a bladed tool for applying an adhesive composition, comprising:
a trough having a first compartment for clean adhesive and a second compartment for contaminated adhesive;
a cleaning slot positioned in a front wall of said second compartment for scraping contaminated adhesive from a blade of the bladed tool;
an arm rest mounted on a rear portion of said trough for resting said trough on a forearm of the user; and,
a handle mounted on a bottom surface of said trough between said arm rest and said front wall of said second compartment, said handle of sufficient size and shape to be comfortably grasped by a user.

16. The trough of claim 15 additionally including a liner for removably lining the second compartment.

17. The trough of claim 15 wherein said handle is a cushioned, pistol grip-type handle mounted between the center of gravity of said trough and a front wall of the second compartment.

18. The trough of claim 15 wherein said handle includes a substantially rigid core covered by a sealed, cushioned cover, and containing within said cover a two part adhesive which, when mixed, will solidify, a first part of said two part adhesive being contained in a first part compartment rupturable by the user, whereby when the user ruptures the first part compartment, mixes the two parts of the adhesive together, and grasps the handle in a normal gripping position, the adhesive will cure and the resulting handle will be permanently conformed to the hand of the user.

19. A method of applying adhesive to a work surface using a bladed tool for applying adhesive and a trough having a first compartment containing clean adhesive and a second compartment for contaminated adhesive, the second compartment including a cleaning slot positioned in a front wall for scraping contaminated adhesive from a blade of a bladed tool, an arm rest mounted on a rear portion of the trough for resting the trough on a forearm of the user; and, a handle mounted on a bottom surface of said trough between said arm rest and said front wall of said second compartment, said handle grasped by a user, the method comprising the steps of:
(1) holding the handle of the trough in a first hand with the arm rest resting on a forearm of the first hand and holding the bladed tool in a second hand;
(2) removing adhesive from the first compartment using a blade of the bladed tool;
(3) transferring the adhesive removed from the first compartment from the blade to a work surface to be coated with adhesive;
(4) repeating steps (2) and (3) until contaminated adhesive is noticed on the blade;
(5) drawing the blade down through the cleaning slot to clean the blade and transfer the contaminated adhesive from the blade to the second compartment; and
(6) repeating steps (2) through (5) as needed.
